(19) United States
(12) Patent Application Publication
(10) Pub. No.: US 2023/0367268 A1
(43) Pub. Date: Nov. 16, 2023

(54) OPTIMIZATION DEVICE AND OPTIMIZATION PROGRAM FOR TOOL PATH

(71) Applicant: FANUC CORPORATION, Minamitsuru-gun, Yamanashi (JP)

(72) Inventor: Yuki INOUE, Yamanashi (JP)

(21) Appl. No.: 18/026,213

(22) PCT Filed: Oct. 21, 2021
(86) PCT No.: PCT/JP2021/038961

§ 371 Date: Mar. 14, 2023

(30) Foreign Application Priority Data
Oct. 28, 2020 (JP) 2020-180565

(51) Int. Cl. G05B 13/02

(52) U.S. Cl. CPC G05B 13/0245

(57) ABSTRACT

An optimization device includes a tool path, an analysis/evaluation unit for inputting one or more evaluation indices each including an evaluation item and weighting, analyzing and evaluating the tool path for each evaluation item, and outputting one or more analysis/evaluation results, and a normalization unit that normalizes the analysis/evaluation results considering the weighting, and outputs one or more normalized analysis/evaluation results. The optimization device also includes a determination unit for inputting a determination criterion, and determining the necessity of path adjustment based on the determination criterion and the normalized analysis/evaluation results such that, when a path adjustment is required, a determination result is outputted including either the normalized analysis/evaluation results or an item requiring adjustment selected from the evaluation items, and a path adjustment unit that performs an adjustment of the tool path based on the determination result, and outputs a path adjustment result including the adjusted tool path.

### TECHNICAL FIELD

The present invention relates to an optimization device and an optimization program, which analyze a tool path in terms of an evaluation item such as machining accuracy and adjust the tool path based on an analysis result to optimize the tool path.

### BACKGROUND ART

In high-quality machining of curved surfaces such as surfaces of molds, there are optimization technologies for optimizing tool paths to acquire smoothly machined surfaces. For example, Patent Document 1 describes a tool path evaluation method for evaluating a tool path when a rotating tool (T) moves relative to a workpiece (W) and machines the workpiece (W). The tool path evaluation method includes: a calculation step of calculating, based on a predefined target tool path (R1) and the shape of the workpiece (W) before being machined through the target tool path (R1), the size of a contact zone (AT) on a bottom surface part (TB), which intersects a tool rotation axis, at a rotating tool tip, over which it is predicted that there is actual contact with the workpiece (W) during machining through the target tool path (R1); and a determination step of determining, when the size of the contact zone (AT) is greater than a predefined threshold value at a desired location on the target tool path (R1), that the target tool path (R1) is deemed inappropriate.

Furthermore, Patent Document 2 describes a numerical control device configured to control a machine tool configured to machine a target to be machined. The numerical control device includes: a path computing unit configured to generate a movement path for a tool, which couples a start point and an end point; a simulation computing unit configured to perform an interference check simulation for determining, when the tool moves along the movement path generated by the path computing unit, whether interference will occur among parts relating to operation of the machine tool, jigs, the target to be machined, and the tool; and a numerical control unit configured to generate, based on the movement path, a program for controlling the machine tool. Then, the path computing unit determines, based on a result of the interference check simulation, whether a correction of the movement path is required or not, and, when it is determined that a correction of the movement path is required, corrects the movement path to a movement path where no interference will occur among the parts, the jigs, the target to be machined, and the tool when the tool moves.
Patent Document 1: PCT International Publication No. WO2015/037143
Patent Document 2: PCT International Publication No. WO2019/082394

### DISCLOSURE OF THE INVENTION

### Problems to be Solved by the Invention

There are various evaluation items for evaluation indices for optimizing a tool path. It is difficult to determine if a tool path needs to be optimized in light of all of a plurality of assumed evaluation items. Furthermore, there is no known technology for determining an evaluation item truly requiring optimization from such a plurality of assumed evaluation items. Therefore, what is demanded is an optimization device and an optimization program for tool path, which make it possible to determine whether a tool path requires optimization or not in light of a plurality of evaluation items and to optimize an evaluation item truly requiring optimization.

### Means for Solving the Problems

(1) A first aspect of the present disclosure is directed to an optimization device for tool path, including: an analysis/evaluation unit into which input data including at least a tool path and one or more evaluation indices each including at least an evaluation item and a weighting are inputted, the analysis/evaluation unit being configured to analyze and evaluate the tool path in terms of each of the evaluation items and to output at least one analysis/evaluation result; a normalization unit configured to normalize the at least one analysis/evaluation result respectively in consideration of the weightings and to output at least one normalized analysis/evaluation result; a determination unit into which a determination criterion is inputted, the determination unit being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from the at least one evaluation item; and a path adjustment unit configured to perform, based on the determination result, the path adjustment of the tool path and to output, to the analysis/evaluation unit, a path adjustment result including at least the adjusted tool path, in which the analysis/evaluation unit performs again an analysis/evaluation based on the adjusted tool path and outputs at least one analysis/evaluation result.

(2) A second aspect of the present disclosure is directed to an optimization program for tool path, causing a computer to achieve functions comprising: an analysis/evaluation function into which input data including at least a tool path and one or more evaluation indices each including at least an evaluation item and a weighting are inputted, the analysis/evaluation function being configured to analyze and evaluate the tool path in terms of each of the at least one evaluation item and to output at least one analysis/evaluation result; a normalization function configured to normalize the at least one analysis/evaluation result respectively in consideration of the at least one weighting and to output at least one normalized analysis/evaluation result; a determination function into which a determination criterion is inputted, the determination function being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from the at least one evaluation item; and a path adjustment function configured to perform, based on the determination result, the path adjustment of the tool path and to output a path adjustment result including at least the adjusted tool path, in which the analysis/evaluation function performs again an analysis/evaluation based on the adjusted tool path and outputs at least one analysis/evaluation result.

### Effects of the Invention

According to the aspects of the present disclosure, it is possible to determine whether a tool path is required to be optimized or not in light of a plurality of evaluation items and to optimize the tool path only when required. Furthermore, according to the aspects of the present disclosure, it is possible to optimize an evaluation item truly requiring optimization.

### BRIEF DESCRIPTION OF THE DRAWINGS

FIG. 1 is a block diagram illustrating an optimization device for tool path, according to an embodiment of the present disclosure;

FIG. 2 is a view for describing a cusp height;

FIG. 3 is a view illustrating a table illustrating a path adjustment determination result according to a first example using the optimization device before adjusting a tool path;

FIG. 4 is a view illustrating a table illustrating a path adjustment determination result according to a second example using the optimization device before adjusting a tool path;

FIG. 5 is a view illustrating an example of adjusting a tool path;

FIG. 6 is a view illustrating a table illustrating a path adjustment determination result according to the first example using the optimization device after adjusting the tool path;

FIG. 7 is a view illustrating a table illustrating a path adjustment determination result according to the second example using the optimization device after adjusting the tool path; and

FIG. 8 is a flowchart illustrating operation of the optimization device for tool path.

### PREFERRED MODE FOR CARRYING OUT THE INVENTION

An embodiment of the present disclosure will now be described herein in detail with reference to the accompanying drawings.

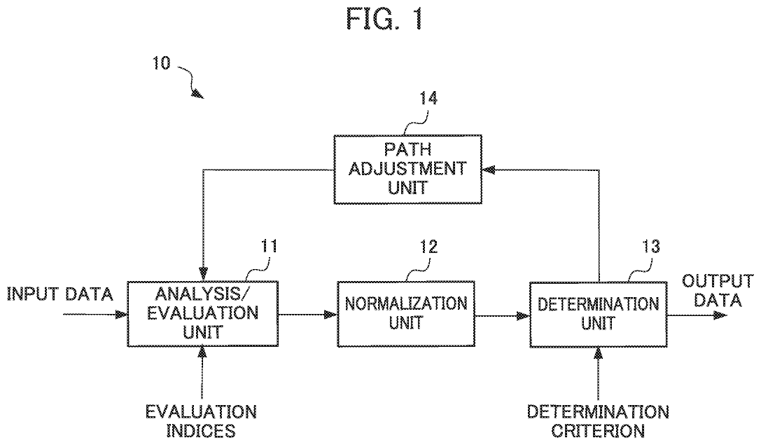

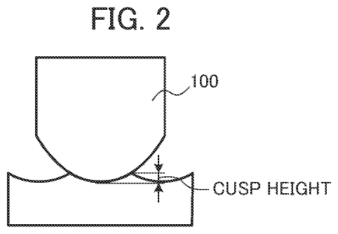

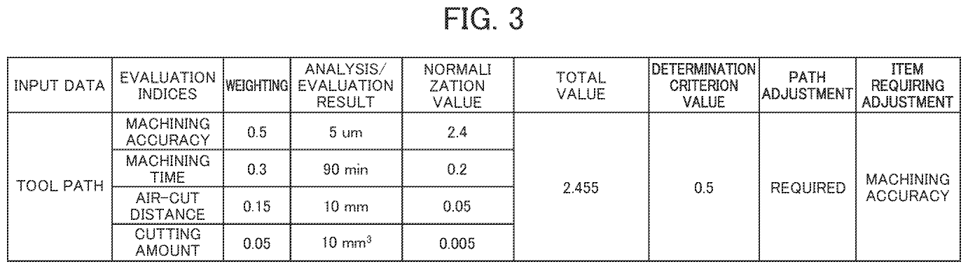

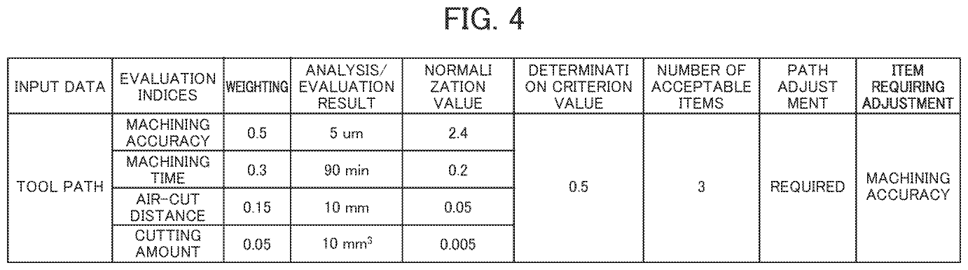

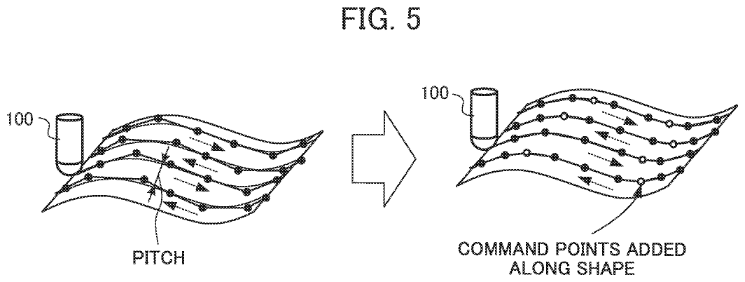

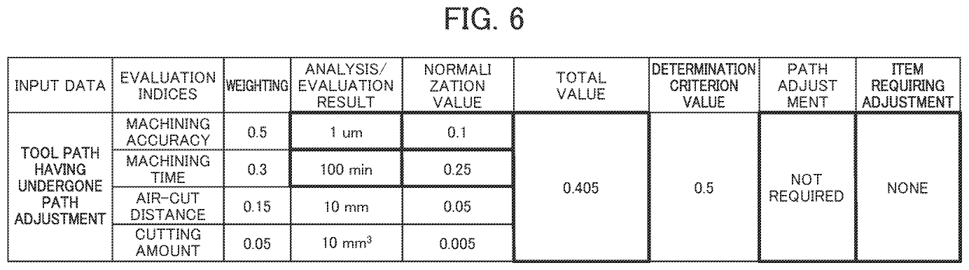

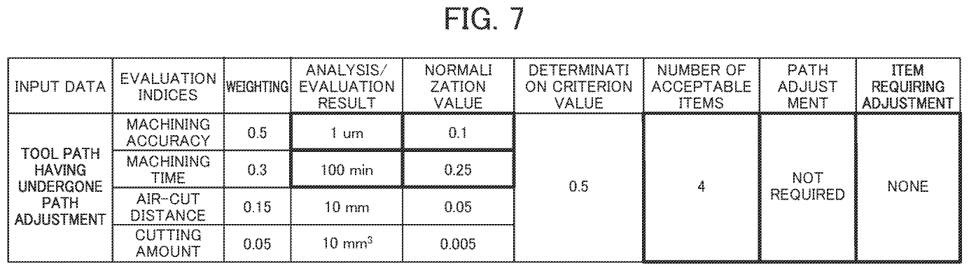

FIG. 1 is a block diagram illustrating an optimization device for tool path, according to an embodiment of the present disclosure. FIG. 2 is a view for describing a cusp height. FIG. 3 is a view illustrating a table relating to a path adjustment determination result according to a first example using the optimization device before adjusting a tool path. FIG. 4 is a view illustrating a table relating to a path adjustment determination result according to a second example using the optimization device before adjusting a tool path. FIG. 5 is a view illustrating an example of adjusting a tool path. FIG. 6 is a view illustrating a table relating to a path adjustment determination result according to the first example using the optimization device after adjusting the tool path. FIG. 7 is a view illustrating a table relating to a path adjustment determination result according to the second example using the optimization device after adjusting the tool path. As illustrated in FIG. 1, an optimization device 10 for tool path includes an analysis/evaluation unit 11, a normalization unit 12, a determination unit 13, and a path adjustment unit 14.

In the analysis/evaluation unit 11, input data and one or more evaluation indices are inputted. The input data includes at least a tool path. However, the input data may include, in addition to the tool path, for example, one or more of tool shape, machining shape, feed rate, size tolerance, geometrical tolerance, or surface roughness. The tool shape is used to arrange a tool on a tool path and to calculate a cusp height illustrated in FIG. 2. The cusp height refers to the height of a projection of pits and projections on a surface machined by a tool 100 such as an end mill and is used to acquire a shape after cutting. The machining shape is used to calculate a distance between the tool path and the machining shape. The feed rate is used to calculate a machining time. The size tolerance, the geometrical tolerance, and the surface roughness are used as target values described later for analyses/evaluations. An evaluation index includes one or more evaluation items and a weighting corresponding to each of the one or more evaluation items. An evaluation item or evaluation items is or are, for example, one or more of machining accuracy, machining time, air-cut distance, or cutting amount. A weighting is set to each evaluation item.

The analysis/evaluation unit 11 is configured to analyze and evaluate an inputted tool path, in terms of each of evaluation items for an inputted evaluation index, and to output one or more analysis/evaluation results. For example, a tool path, a machining shape, and a feed rate are inputted as input data to the analysis/evaluation unit 11. The analysis/evaluation unit 11 calculates, as illustrated in the tables in FIGS. 3 and 4, 5 μm as the machining accuracy, 90 min as the machining time, 10 mm as the air-cut distance, and 10 mm³ as the cutting amount. These calculation results serve as analysis/evaluation results. The machining accuracy is acquired by calculating an error between the shape after cutting through the tool path and the machining shape. The machining time is calculated using an equation of (distance of tool path)/(feed rate). The air-cut distance is acquired by calculating a distance of the tool path through which the raw material has not yet undergone cutting. The cutting amount is acquired by calculating a volume to be cut through the tool path and from the machining shape.

The normalization unit 12 is configured to make pieces of data, which differ from each other in type, in the analysis/evaluation results dimensionless and to perform a calculation by multiplying a value that has been made dimensionless by a weighting. Hereinafter this calculation processing will be referred to as normalization, and a normalized value will be referred to as a normalization value. Performing normalization makes it possible to compare analysis/evaluation results, which differ from each other in unit or scale, for example, with each other. A method of making pieces of data, which differ from each other in type, dimensionless is not limited to a particular processing method. However, in the present embodiment, the normalization unit 12 acquires, through |analysis/evaluation results−representative value|/(representative value), a value that has been made dimensionless. The magnitude of a weighting determines a degree of importance of an evaluation item.

A specific calculation method for normalization will now be described with reference to FIGS. 3 and 4. It is assumed herein that representative values are used as target values, and the target values of the machining accuracy, the machining time, the air-cut distance, and the cutting amount respectively are 0.85 μm, 55 min, 7.5 mm, and 9.091 mm³. These target values are calculated from the tool path. It is assumed herein that the weightings for the machining accuracy, the machining time, the air-cut distance, and the cutting amount respectively are 0.5, 0.3, 0.15, and 0.05. A weighting is set by a user per evaluation item. A calculation equation of {(5 μm−0.85 μm)/(0.85 μm)}×(0.5) is used to acquire a normalization value of 2.4 for the machining accuracy. A calculation equation of {(90 min−55 min)/(55 min}×(0.3) is used to acquire a normalization value of 0.2 for the machining time. A calculation equation of {(10 mm−7.5 mm)/(7.5 mm}×(0.15) is used to acquire a normalization value of 0.05 for the air-cut distance. A calculation equation of {(10 mm³−9.091 mm³)/(9.091 mm³}×(0.05) is used to acquire a normalization of 0.005 value for the cutting amount.

The determination unit 13 is configured to determine, based on an inputted determination criterion and the normalized analysis/evaluation results, whether a path adjustment is required or not. Examples will now be described below, where the determination unit 13 determines, based on an inputted determination criterion and normalized analysis/evaluation results, whether a path adjustment is required or not. A first example is an example where the determination unit 13 totals normalization values for a plurality of evaluation items for an evaluation index, compares the acquired total value with an inputted determination criterion value, and determines whether an adjustment of the tool path is required or not. The determination unit 13 determines, when the total value is equal to or greater than the determination criterion value, that an adjustment of the tool path is required and determines, when the total value is less than the determination criterion, that no adjustment of the tool path is required. The table in FIG. 3 illustrates the first example, where the determination unit 13 compares a total value of 2.455 acquired by totaling the normalization values of 2.4, 0.2, 0.05, and 0.005, respectively for the machining accuracy, the machining time, the air-cut distance, and the cutting amount with the inputted determination criterion value of 0.5 and, since the total value of 2.455 is equal to or greater than the determination criterion value of 0.5, determines that an adjustment of the tool path is required.

A second example is an example where the determination unit 13 compares each of normalized values respectively for a plurality of evaluation items for an evaluation index with an inputted determination criterion value, deems evaluation items, the values of which are each less than the determination criterion value, as acceptable items, and determines, based on the number of acceptable items, whether an adjustment of the tool path is required or not. The determination unit 13 determines, when the number of acceptable items is equal to or less than a certain number, that an adjustment of the tool path is required and determines, when the number of acceptable items is greater than the certain number, that no adjustment of the tool path is required. The table in FIG. 4 illustrates the second example, where the certain number serving as a criterion for the number of acceptable items is three, and the determination unit 13 compares each of the normalization values of 2.4, 0.2, 0.05, and 0.005 respectively for the machining accuracy, the machining time, the air-cut distance, and the cutting amount with the inputted determination criterion value of 0.5 and determines, since each of the normalization values of 0.2, 0.05, and 0.005 respectively for the machining time, the air-cut distance, and the cutting amount is less than the determination criterion value of 0.5 and the number of acceptable items is three, that is, the number of acceptable items is equal to or less than the certain number, that an adjustment of the tool path is required.

The determination unit 13 may compare each of normalized values respectively for a plurality of evaluation items for an evaluation index with an inputted determination criterion value and may determine, for each evaluation item among the plurality of evaluation items, whether an adjustment of the tool path is required or not.

The determination unit 13 compares, when it is determined that an adjustment of the tool path is required, the normalized analysis/evaluation results with each other and selects, based on a magnitude relationship among the normalized analysis/evaluation results, an item requiring adjustment from the evaluation items for the evaluation index. For example, the determination unit 13 selects, as one or more items requiring adjustment, one or more evaluation items in a descending order from the largest normalization value from among evaluation items for an evaluation index. In the examples illustrated as the tables in FIGS. 3 and 4, the determination unit 13 selects, as an item requiring adjustment, the machining accuracy representing an evaluation item presenting the largest normalization value from among the evaluation items for the evaluation index.

The determination unit 13 outputs, when it is determined that a path adjustment is required, a determination result including either of the normalized analysis/evaluation results and one or more of items requiring adjustment selected from the evaluation items to the path adjustment unit 14. Note that the determination unit 13 may select no item requiring adjustment when no item requiring adjustment is to be outputted. The determination unit 13 may include, in a determination result, either or both of a tool path and analysis/evaluation results. One reason for this is that, in an adjustment of a tool path by the path adjustment unit 14, the tool path may be used and/or analysis/evaluation results may be used. A determination result may include no tool path. In such a case, it is possible to output a tool path from the analysis/evaluation unit 11 to the path adjustment unit 14 described later.

On the other hand, the determination unit 13 outputs externally, when it is determined that no path adjustment is required, the tool path or a tool path adjusted by the path adjustment unit 14. Note that the determination unit 13 may output, in addition to a tool path or an adjusted tool path, at least one of analysis/evaluation results or normalized analysis/evaluation results. The determination unit 13 may allow a display device such as a liquid crystal display device to display at least one of analysis/evaluation results or normalized analysis/evaluation results to enable the user to recognize them.

The path adjustment unit 14 is configured to adjust, when a determination result includes one or more normalized analysis/evaluation results, the tool path to make reductions in one or more analysis/evaluation results for one or more evaluation items in a descending order from the largest normalized value and to output an adjusted tool path to the analysis/evaluation unit 11. For example, in the examples illustrated in FIGS. 3 and 4, the path adjustment unit 14 adjusts the tool path to make a reduction in the value of the machining accuracy that is an evaluation item presenting the largest normalized value. The path adjustment unit 14 adjusts, when a determination result includes an item requiring adjustment, the tool path to make a reduction in the analysis/evaluation result for the item requiring adjustment and outputs an adjusted tool path to the analysis/evaluation unit 11. For example, in the examples illustrated in FIGS. 3 and 4, the path adjustment unit 14 adjusts the tool path to make a reduction in the value of the machining accuracy since the item requiring adjustment is the machining accuracy.

When a tool path is to be adjusted to improve machining accuracy, it is enough that command points are added on the tool path, and, to reduce a machining time, it is enough that command points on the tool path are reduced or the feed rate is increased. Furthermore, for example, to shorten an air-cut distance, it is enough that air-cut sections are reduced, and, to reduce a cutting amount, it is enough that a pitch (illustrated in FIG. 5) is reduced or a cutting amount along the tool path is changed. FIG. 5 illustrates an example when command points are added on a tool path to improve machining accuracy. In FIG. 5, arrows each with a dotted line indicate directions in which the tool 100 moves back and forth. As illustrated in FIG. 5, adding command points on a tool path of the tool 100 along a machined surface improves its machining accuracy. However, there may be a tendency that a tool speed does not increase, extending a machining time.

The analysis/evaluation unit 11 analyzes and evaluates again the inputted tool path having undergone the path adjustment and outputs analysis/evaluation results to the normalization unit 12. The normalization unit 12, the determination unit 13, and the path adjustment unit 14 further perform the operation described above for the analysis/evaluation results acquired again. FIG. 6 is a view illustrating a table illustrating a path adjustment determination result according to the first example using the optimization device after adjusting the tool path. FIG. 7 is a view illustrating a table illustrating a path adjustment determination result according to the second example using the optimization device after adjusting the tool path. As illustrated in FIGS. 6 and 7, the path adjustment causes the analysis/evaluation result for the machining accuracy to shift from 5 μm illustrated in FIG. 3 and 4 to 1 μm, that is, the machining accuracy has been improved. However, the analysis/evaluation result for the machining time has shifted from 90 min illustrated in FIG. 3 and 4 to 100 min, that is, the machining time has been extended. Then, the normalization values of the machining accuracy and the machining time have respectively shifted from 2.4 and 0.2 to 0.1 and 0.25. In FIGS. 6 and 7, those shifted from those in FIGS. 3 and 4 are each indicated by a bold rectangle.

In the first example, the total of the normalized values has shifted, as illustrated in FIG. 6, from 2.455 illustrated in FIG. 3 to 0.405. When this value is compared with the determination criterion value of 0.5, the total value of 0.405 is less than the determination criterion value of 0.5. Then the determination unit 13 determines that no more adjustment is required for the tool path. In the second example, the number of acceptable items has shifted, as illustrated in FIG. 7, from three to four, exceeding three that is the certain number serving as the reference number of acceptable items. Therefore, the determination unit 13 determines that no more adjustment is required for the tool path. Then, the determination unit 13 outputs externally the tool path. As described above, the determination unit 13 may output, in addition to the tool path, at least one of analysis/evaluation results or normalized analysis/evaluation results.

The functional blocks included in the optimization device 10 for tool path have been described above. To achieve these functional blocks, the optimization device 10 for tool path is constructed with, for example, a computer including an arithmetic processing unit such as a central machining unit (CPU). Furthermore, the optimization device for tool path further includes an auxiliary storage such as a hard disk drive (HDD) that stores programs for various types of control, including an optimization program or an operating system (OS), and a main storage such as random access memory (RAM) that stores data that the arithmetic processing unit temporarily requires to execute the programs.

In the optimization device for tool path, the arithmetic processing unit then reads the optimization program or the OS from the auxiliary storage, deploys the read optimization program or the read OS into the main storage, and performs arithmetic processing based on the optimization program or the OS. Furthermore, the arithmetic processing device controls various types of hardware disposed in respective devices based on an arithmetic operation result. In this way, the function blocks of the present embodiment are implemented. That is, it is possible to achieve the present embodiment when the hardware and the software cooperate with each other.

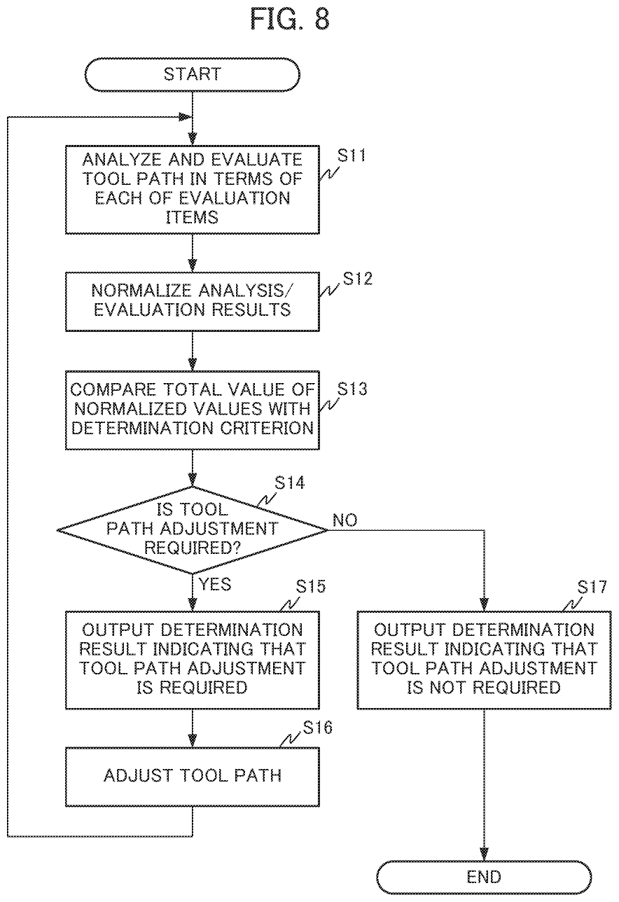

Next, operation of the optimization device 10 for tool path will now be described with reference to a flowchart. FIG. 8 is a flowchart illustrating operation of the optimization device for tool path. In the below description, the first example is described, where the determination unit 13 totals normalization values for a plurality of evaluation items for an evaluation index to calculate a total value, compares the calculated total value with an inputted determination criterion value, and determines whether an adjustment of the tool path is required or not. The optimization program executes steps illustrated in FIG. 8.

At Step S11, the analysis/evaluation unit 11 analyzes and evaluates an inputted tool path, in terms of each of evaluation items for an inputted evaluation index, and outputs analysis/evaluation results to the normalization unit 12.

At Step S12, the normalization unit 12 normalizes the analysis/evaluation results, i.e., makes pieces of data, which differ from each other in type, in the analysis/evaluation results dimensionless, and performs a calculation by multiplying a value that has been made dimensionless by a weighting. For example, the normalization unit 12 acquires, through |analysis/evaluation results−representative value|/(representative value), a value that has been made dimensionless and performs a calculation by multiplying the value that has been made dimensionless by a (weighting).

At Step S13, the determination unit 13 calculates a total value of the normalized values for the plurality of evaluation items for the evaluation index and compares the calculated total value with an inputted determination criterion value.

At Step S14, it is determined whether an adjustment of the tool path is required or not. The determination unit 13 determines, when the total value is equal to or greater than the determination criterion value, that an adjustment of the tool path is required and causes the processing to proceed to Step S15. The determination unit 13 determines, when the total value is less than the determination criterion value, that no adjustment of the tool path is required and causes the processing to proceed to Step S17.

At Step S15, the determination unit 13 selects, as one or more items requiring adjustment, one or more evaluation items in a descending order from the largest normalized value from among the evaluation items for the evaluation index and outputs a determination result including the item or the items requiring adjustment to the path adjustment unit 14.

At Step S16, the path adjustment unit 14 adjusts the tool path to make reductions in the analysis/evaluation results for the item or items requiring adjustment, outputs an adjusted tool path to the analysis/evaluation unit 11, and causes the processing to return to Step S11.

At Step 17, the determination unit 13 outputs externally the tool path and causes the processing to end.

At Step S13 as described above, the determination unit 13 may use the second example where each of normalized values respectively for a plurality of evaluation items for an evaluation index is compared with an inputted determination criterion value and, for an evaluation item that is less than the determination criterion value, it is determined, based on the number of acceptable items, whether an adjustment of the tool path is required or not. Furthermore, at Step S15, the determination unit 13 may output, instead of an item requiring adjustment or in addition to an item requiring adjustment, normalized analysis/evaluation results to the path adjustment unit 14. Furthermore, at Step S16, the path adjustment unit 14 may adjust, when a determination result includes, instead of an item requiring adjustment, normalized analysis/evaluation results, the tool path to make reductions in one of the analysis/evaluation results, for an evaluation item presenting the largest normalized value, may output an adjusted tool path to the analysis/evaluation unit 11, and may cause the processing to return to Step S11.

According to the embodiment described above, it is possible to determine whether a tool path is required to be optimized or not in light of a plurality of evaluation items and to optimize the tool path only when required. Furthermore, it is possible to optimize an evaluation item truly requiring optimization.

The optimization device for tool path, according to the present embodiment, has been described above. However, it is possible to provide the optimization device for tool path, according to the present embodiment, in a numerical control device provided as a part of a machine tool or provided separately from a machine tool or in a computer aided manufacturing (CAM) device that outputs a machining program to a numerical control device. The optimization device for tool path, according to the present embodiment, may be provided separately from a numerical control device and a CAM device.

The embodiment of the present invention has been described above. It is possible to achieve the components included in the optimization device for tool path, according to the present embodiment, in the form of hardware, software, or a combination thereof. Furthermore, it is possible to achieve the optimization program to be executed through cooperation with each other of the components included in the optimization device described above, in the form of software or a combination of hardware and software. Herein, achievement in the form of software means achievement when a computer reads and executes a program.

It is possible to use a non-transitory computer readable medium that varies in type to store the program, and to supply the program to a computer. Examples of the non-transitory computer readable medium include tangible storage media that vary in type. Examples of the non-transitory computer readable medium include magnetic recording media (for example, hard disk drives), magneto-optical recording media (for example, magneto-optical discs), compact discs read only memory (CD-ROMs), compact discs-recordable (CD-Rs), compact discs-rewritable (CD-R/Ws), and semiconductor memories (for example, mask ROMs, programmable ROMs (PROMs), erasable PROMs (EPROMs), flash ROMs, and random access memories (RAMs)).

The above-described embodiment represents a preferred embodiment of the present invention. However, the scope of the present invention is not limited to the embodiment described above, and it is possible to embody the present invention in various modifications without departing from the spirit of the present invention.

It is possible that the optimization device for tool path and the optimization program, according to the present disclosure, take various types of embodiments having configurations described below, including the embodiment described above.

(1) An optimization device for tool path, including: an analysis/evaluation unit into which input data including at least a tool path and one or more evaluation indices each including at least an evaluation item and a weighting are inputted, the analysis/evaluation unit being configured to analyze and evaluate the tool path in terms of each of the evaluation items and to output at least one analysis/evaluation result; a normalization unit configured to normalize the at least one analysis/evaluation result respectively in consideration of the weightings and to output at least one normalized analysis/evaluation result; a determination unit into which a determination criterion is inputted, the determination unit being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from the at least one evaluation item; and a path adjustment unit configured to perform, based on the determination result, the path adjustment of the tool path and to output, to the analysis/evaluation unit, a path adjustment result including at least the adjusted tool path, in which the analysis/evaluation unit performs again an analysis/evaluation based on the adjusted tool path and outputs at least one analysis/evaluation result.

According to this optimization device for tool path, it is possible to determine whether a tool path is required to be optimized or not in light of a plurality of evaluation items and to optimize the tool path only when required. Furthermore, it is possible to optimize an evaluation item truly requiring optimization.

(2) The optimization device described in (1) above, in which the input data includes, in addition to the tool path, at least one of tool shape, machining shape, feed rate, size tolerance, geometrical tolerance, or surface roughness.

(3) The optimization device described in (1) or (2) above, in which the analysis/evaluation unit calculates and acquires the at least one analysis/evaluation result from the input data.

(4) The optimization device described in any one of (1) to (3) above, in which the at least one weighting respectively indicate degrees of importance of the at least one evaluation item.

(5) The optimization device described in any one of (1) to (4), in which the determination unit determines whether a path adjustment is required or not based on whether a total value of a plurality of the normalized analysis/evaluation results satisfies the determination criterion.

(6) The optimization device described in any one of (1) to (4), in which the determination unit determines at least one acceptable item each satisfying the determination criterion, respectively for the at least one normalized analysis/evaluation result, and determines whether a path adjustment is required or not based on whether a number of the acceptable items is greater than a certain number.

(7) The optimization device described in any one of (1) to (6) above, in which the determination unit compares the normalized analysis/evaluation results with each other and selects, based on a magnitude relationship among the normalized analysis/evaluation results, the item requiring adjustment from the evaluation items.

(8) The optimization device described in any one of (1) to (7) above, in which the determination unit outputs externally, when it is determined that the path adjustment is not required, at least the tool path or the tool path having undergone the adjustment.

(9) An optimization program for tool path, causing a computer to achieve functions comprising: an analysis/evaluation function into which input data including at least a tool path and one or more evaluation indices each including at least an evaluation item and a weighting are inputted, the analysis/evaluation function being configured to analyze and evaluate the tool path in terms of each of the at least one evaluation item and to output at least one analysis/evaluation result; a normalization function configured to normalize the at least one analysis/evaluation result respectively in consideration of the at least one weighting and to output at least one normalized analysis/evaluation result; a determination function into which a determination criterion is inputted, the determination function being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from at least one the evaluation item; and a path adjustment function configured to perform, based on the determination result, the path adjustment of the tool path and to output a path adjustment result including at least the adjusted tool path, in which the analysis/evaluation function performs again an analysis/evaluation based on the adjusted tool path and outputs at least one analysis/evaluation result.

According to this optimization program for tool path, it is possible to determine whether a tool path is required to be optimized or not in light of a plurality of evaluation items and to optimize the tool path only when required. Furthermore, it is possible to optimize an evaluation item truly requiring optimization.

(10) The optimization program described in (9) above, in which the input data includes, in addition to the tool path, at least one or more of tool shape, machining shape, feed rate, size tolerance, geometrical tolerance, or surface roughness.

(11) The optimization program described in (9) or (10) above, in which the analysis/evaluation function calculates and acquires the at least one analysis/evaluation result from the input data.

(12) The optimization program described in any one of (9) to (11), in which the at least one weighting respectively indicate degrees of importance of the at least one evaluation item.

(13) The optimization program described in any one of (9) to (12) above, in which the determination function determines whether a path adjustment is required or not based on whether a total value of a plurality of the normalized analysis/evaluation results satisfies the determination criterion.

(14) The optimization program described in any one of (9) to (12) above, in which the determination function determines at least one acceptable item each satisfying the determination criterion, respectively for the at least one normalized analysis/evaluation result, and determines whether a path adjustment is required or not based on whether a number of the at least one acceptable item is greater than a certain number.

(15) The optimization program described in any one of (9) to (14) above, in which the determination function compares the normalized analysis/evaluation results with each other and selects, based on a magnitude relationship among the normalized analysis/evaluation results, the item requiring adjustment from the evaluation items.

(16) The optimization program described in any one of (9) to (15) above, in which the determination function outputs externally, when it is determined that the path adjustment is not required, at least the tool path or the tool path having undergone the adjustment.

### EXPLANATION OF REFERENCE NUMERALS

10 Optimization device for tool path
11 Analysis/evaluation unit
12 Normalization unit
13 Determination unit
14 Path adjustment unit
100 Tool

1. An optimization device for tool path, comprising:
an analysis/evaluation unit into which input data including at least a tool path and one or more evaluation indices each including at least an evaluation item and a weighting are inputted, the analysis/evaluation unit being configured to analyze and evaluate the tool path in terms of each of the evaluation items and to output at least one analysis/evaluation result;
a normalization unit configured to normalize the at least one analysis/evaluation result respectively in consideration of the weightings and to output at least one normalized analysis/evaluation result;
a determination unit into which a determination criterion is inputted, the determination unit being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from the at least one evaluation items; and
a path adjustment unit configured to perform, based on the determination result, the path adjustment of the tool path and to output, to the analysis/evaluation unit, a path adjustment result including at least the adjusted tool path,
wherein the analysis/evaluation unit performs again an analysis/evaluation based on the adjusted tool path and outputs at least one analysis/evaluation result.

2. The optimization device according to claim 1, wherein the input data includes, in addition to the tool path, at least one or more of tool shape, machining shape, feed rate, size tolerance, geometrical tolerance, or surface roughness.

3. The optimization device according to claim 1, wherein the analysis/evaluation unit calculates and acquires the at least one analysis/evaluation result from the input data.

4. The optimization device according to claim 1, wherein the at least one weighting respectively indicate degrees of importance of the at least one evaluation item.

5. The optimization device according to claim 1, wherein the determination unit determines whether a path adjustment is required or not based on whether a total value of a plurality of the normalized analysis/evaluation results satisfies the determination criterion.

6. The optimization device according to claim 1, wherein the determination unit determines at least one acceptable item each satisfying the determination criterion, respectively for the at least one normalized analysis/evaluation result, and determines whether a path adjustment is required or not based on whether a number of the acceptable items is greater than a certain number.

7. The optimization device according to claim 1, wherein the determination unit compares the normalized analysis/evaluation results with each other and selects, based on a magnitude relationship among the normalized analysis/evaluation results, the item requiring adjustment from the evaluation items.

8. The optimization device according to claim 1, wherein the determination unit outputs externally, when it is determined that the path adjustment is not required, at least the tool path or the tool path having undergone the adjustment.

9. A non-transitory computer readable recording medium encoded with an optimization program for tool path, causing a computer to achieve functions comprising:
an analysis/evaluation function into which input data including at least a tool path and one or more evaluation indices each including at least an evaluation item and a weighting are inputted, the analysis/evaluation function being configured to analyze and evaluate the tool path in terms of each of the at least one evaluation item and to output at least one analysis/evaluation result;
a normalization function configured to normalize the at least one analysis/evaluation result respectively in consideration of the at least one weighting and to output at least one normalized analysis/evaluation result;
a determination function into which a determination criterion is inputted, the determination function being configured to determine whether a path adjustment is required or not based on the determination criterion and the at least one normalized analysis/evaluation result and to output, when it is determined that the path adjustment is required, a determination result including at least one of the at least one normalized analysis/evaluation result or an item requiring adjustment selected from the at least one evaluation item; and
a path adjustment function configured to perform, based on the determination result, the path adjustment of the tool path and to output a path adjustment result including at least the adjusted tool path,
wherein the analysis/evaluation function performs again an analysis/evaluation based on the adjusted tool path and outputs at least one analysis/evaluation result.

10. The non-transitory computer readable recording medium according to claim 9, wherein the input data includes, in addition to the tool path, at least one or more of tool shape, machining shape, feed rate, size tolerance, geometrical tolerance, or surface roughness.

11. The non-transitory computer readable recording medium according to claim 9, wherein the analysis/evaluation function calculates and acquires the at least one analysis/evaluation result from the input data.

12. The non-transitory computer readable recording medium according to claim 9, wherein the at least one weighting respectively indicate degrees of importance of the at least one evaluation item.

13. The non-transitory computer readable recording medium according to claim 9, wherein the determination function determines whether a path adjustment is required or not based on whether a total value of a plurality of the normalized analysis/evaluation results satisfies the determination criterion.

14. The non-transitory computer readable recording medium according to claim 9, wherein the determination function determines at least one acceptable item each satisfying the determination criterion, respectively for the at least one normalized analysis/evaluation result, and determines whether a path adjustment is required or not based on whether a number of the at least one acceptable item is greater than a certain number.

15. The non-transitory computer readable recording medium according to claim 9, wherein the determination function compares the normalized analysis/evaluation results with each other and selects, based on a magnitude relationship among the normalized analysis/evaluation results, the item requiring adjustment from the evaluation items.

16. The non-transitory computer readable recording medium according to claim 9, wherein the determination function outputs externally, when it is determined that the path adjustment is not required, at least the tool path or the tool path having undergone the adjustment.
